(19) United States
(12) Patent Application Publication
(10) Pub. No.: US 2020/0039498 A1
(43) Pub. Date: Feb. 6, 2020

(54) MODULATION OF BATTERY REGENERATION FOR A HYBRID VEHICLE

(71) Applicant: XL Hybrids, Inc., Boston, MA (US)

(72) Inventors: Bill Passman, Lexington, MA (US); Tejas Chafekar, Newton, MA (US)

(21) Appl. No.: 16/531,618

(22) Filed: Aug. 5, 2019

Related U.S. Application Data
(60) Provisional application No. 62/714,914, filed on Aug. 6, 2018.

(51) Int. Cl. B60W 20/00

(52) U.S. Cl. CPC B60W 20/00; B60W 2540/10; B60W 2520/10; B60W 2420/42; B60K 6/28; B60W 2520/105; B60W 2550/10; B60W 2510/244; B60W 2550/14; B60W 2550/22

(57) ABSTRACT

A system, computer readable media storing instructions, and a computing device-implemented method comprise receiving information representative of an environment forward of a travelling vehicle that includes an alternative fuel propulsion system, receiving information representative of a position of an accelerator pedal of the vehicle, and determining a battery regeneration profile to send to an electric motor of the alternative fuel propulsion system of the vehicle from the received information representative of a position of a pedal and the information.

### CROSS-REFERENCE TO RELATED APPLICATIONS

This application claims the benefit under 35 U.S.C. § 119(e) of U.S. Patent Application No. 62/714,914, entitled “Modulation of Battery Regeneration for a Hybrid Conversion,” filed Aug. 6, 2018, which is incorporated herein by reference in its entirety.

### TECHNICAL FIELD

This disclosure relates to techniques for dynamically controlling battery regeneration in a hybrid electric vehicle.

### BACKGROUND

With the increased interest in reducing dependency on fossil fuels, the use of alternative energy sources has been incorporated into various applications such as transportation. Both public and private transportation vehicles have been developed to run on a fuel other than traditional petroleum based fuels (e.g., petrol, diesel, etc.). Some vehicles solely use alternative energy sources while others combine the functionality of petroleum-based systems with alternative energy based systems (e.g., electrical, biofuel, natural gas, etc.). Along with being potentially more cost-effective and having more abundant resources, such alternative energy sources and their byproducts are considered more environmentally friendly.

### SUMMARY

The systems and techniques described here relate to using sensor data in a hybrid electric vehicle that includes an alternative energy-based system (e.g., an electric motor with battery) to assist a traditional petroleum-based internal combustion engine for efficient management of combustible fuel onboard the vehicle. These management techniques achieve more efficient use of the internal combustion engine by assistance from the alternative energy system, thereby conserving fuel.

When a driver of a hybrid vehicle takes his or her foot off the accelerator or presses the brakes, the hybrid system generally attempts to regenerate the battery by converting the kinetic energy of the vehicle's motion into electric energy that is fed to the battery, thereby slowing down the vehicle. Typically, hybrid systems try to maximize this regeneration of the vehicle's battery and regain as much battery charge as possible. However, approximately 40% of typical driving time takes place with the driver's foot on neither pedal while the vehicle coasts, for example, when following behind a vehicle, easing to a stop, or going downhill. At such times, the driver may not in fact wish to slow down the vehicle, which occurs as a side effect of the regeneration process. The systems and techniques described use sensor data to infer driver intent to modulate hybrid energy by controlling when or if battery regeneration should begin, and thereby slow down the vehicle. This modification in signaling is a dynamic process, whereby the system predicts the intent of the driver each instance she removes her foot from the accelerator pedal so that the hybrid system does not slow the vehicle in situations where the driver may not intend such a response, or slows the vehicle less rapidly than the hybrid system otherwise would. The result is similar (or in some cases, improved) vehicle performance accompanied by a reduced amount of combustible fuel used.

A computing device-implemented method includes receiving information representative of an environment forward of a travelling vehicle that includes an alternative fuel propulsion system, receiving information representative of a vehicle performance measure, receiving information representative of a position of an accelerator pedal of the vehicle, and determining a battery regeneration profile to send to an electric motor of the alternative fuel propulsion system of the vehicle from the received information representative of the position of a pedal, the received information representative of the vehicle performance measure, and received information representative of the environment.

In some implementations, the method comprises one or more of the following. The performance measure represents a speed of the vehicle. The information representative of the environment is camera images of a road segment in front of the vehicle. Detecting an object of interest from the camera images. The object of interest includes a vehicle, a stop light, a stop sign, or a barrier. Determining an acceleration of the vehicle relative to the object of interest. The information representative of the environment is visual information.

A system includes a computing device including a memory configured to store instructions, and a processor to execute the instructions to perform operations comprising: receiving information representative of an environment forward of a travelling vehicle that includes an alternative fuel propulsion system, receiving information representative of a vehicle performance measure, receiving information representative of a position of an accelerator pedal of the vehicle, and determining a battery regeneration profile to send to an electric motor of the alternative fuel propulsion system of the vehicle from the received information representative of the position of a pedal, the received information representative of the vehicle performance measure, and received information representative of the environment.

In some implementations, the method comprises one or more of the following. The performance measure represents a speed of the vehicle. The information representative of the environment is camera images of a road segment in front of the vehicle. Detecting an object of interest from the camera images. The object of interest includes a vehicle, a stop light, a stop sign, or a barrier. Determining an acceleration of the vehicle relative to the object of interest. The information representative of the environment is visual information.

One or more computer readable media storing instructions that are executable by a processing device, and upon such execution cause the processing device to perform operations including receiving information representative of an environment forward of a travelling vehicle that includes an alternative fuel propulsion system, receiving information representative of a vehicle performance measure, receiving information representative of a position of an accelerator pedal of the vehicle, and determining a battery regeneration profile to send to an electric motor of the alternative fuel propulsion system of the vehicle from the received information representative of the position of a pedal, the received information representative of the vehicle performance measure, and received information representative of the environment.

In some implementations, the method comprises one or more of the following. The performance measure represents a speed of the vehicle. The information representative of the environment is camera images of a road segment in front of the vehicle. Detecting an object of interest from the camera images. The object of interest includes a vehicle, a stop light, a stop sign, or a barrier. Determining an acceleration of the vehicle relative to the object of interest. The information representative of the environment is visual information.

Regenerative braking is an energy-saving technique used in vehicles with electric motors. When an electric motor runs in one direction, it converts electrical energy into mechanical energy that can be used to perform work (e.g., turning the wheels of a car). When the motor is run in the opposite direction, it converts mechanical energy into electrical energy. This generated electrical energy can then be fed into a charging system and stored in the vehicle's batteries, a process called regeneration.

In previous electric vehicles, removing one's foot from the accelerator pedal was interpreted by the system as a desire on the part of the user to start braking. Regeneration causes slowing of the vehicle, so the system would immediately begin battery regeneration. The goal of such a quick reaction is to maximize regeneration; high regeneration slows down the vehicle a great deal, even to the extent of effectively replacing the brake pedal. However, fuel efficiency can suffer as the driver may then quickly re-engage the accelerator pedal if the driver's intent was not to slow down so precipitously. Some vehicles introduce a dial the driver could use to modulate the amount of brake regeneration used (and hence deceleration) to avoid undesirable slowing of the vehicle every time the driver's foot is removed from the accelerator pedal.

Some conventional systems account for undesirable slowing due to regeneration when the driver's foot is removed from the accelerator pedal by incorporating a response delay. Such systems include a delay of 1-2 seconds for the driver to coast when he removes his foot from the accelerator pedal before the system ramps up the regeneration forces and slows down the vehicle.

The systems and techniques described here have many advantages over conventional systems. Here, the need for the driver to press the accelerator pedal is reduced. As a result, the internal combustion engine is not signaled to provide power, or signaled for a lesser increase in power, than would be required absent these techniques that modulate the regeneration profile. Reducing pressing the accelerator pedal minimizes fuel consumption. Correctly modulating the regeneration profile eliminates inefficiency caused by a driver speeding back up after battery regeneration causes the vehicle to slow down without the intent of the driver to do so. Correctly modulating the regeneration profile also reduces mechanical breaking of the traditional braking system that a driver of a hybrid vehicle does, while allowing vehicle slowing to be caused by regeneration. Calculating the regeneration profile required to come to a desired stop predicted by the vehicle's sensors allows all kinetic energy (minus unavoidable losses) from the vehicle's forward motion to translate into stored energy. In addition to improving battery regeneration, this decreases mechanical brake wear as the driver will have to press the brake pedal less often than before.

Advantageously, the signal modification is dynamic, responding to changing conditions as detected by the vehicle sensors.

These and other aspects and features and various combinations of them may be expressed as methods, apparatus, systems, means for performing functions, program products, and in other ways. Other features, objects, and advantages of the invention will be apparent from the description and drawings, and from the claims.

### DESCRIPTION OF DRAWINGS

FIG. 1 illustrates a vehicle that includes a regeneration profile calculator for its electric propulsion system.

FIG. 2 illustrates a network-based assistance manager for managing propulsion systems of multiple vehicles.

FIG. 3 illustrates a diagram of a regeneration profile calculator.

FIGS. 4A-C illustrate a driving scenario and vehicle responses with and without a regeneration profile correction.

FIGS. 5A-B illustrate additional driving scenarios employing a regeneration profile calculator.

FIG. 6 illustrates an additional embodiment of a system implementing a regeneration profile calculator in addition to a torque assistance manager.

FIG. 7 is a flow chart of representative operations for an assistance manager.

FIG. 8 is a block diagram of computing devices and systems.

Like reference symbols in the various drawings indicate like elements.

### DETAILED DESCRIPTION

The systems and techniques described here relate to using sensor data in a hybrid electric vehicle including an alternative energy-based system (e.g., an electric motor with battery), as well as any aftermarket hybrid systems (including hydraulic systems), that assists a traditional petroleum-based internal combustion engine for efficient management of combustible fuel onboard the vehicle. These management techniques achieve more efficient use of the internal combustion engine by assistance from the alternative energy system, thereby conserving fuel.

When a driver of a hybrid vehicle takes his or her foot off the accelerator or presses the brakes, the hybrid system generally attempts to regenerate the battery by converting the kinetic energy of the vehicle's motion into electric energy that is fed to the battery, thereby slowing down the vehicle. Typically, hybrid systems try to maximize this regeneration of the vehicle's battery and regain as much battery charge as possible. However, approximately 40% of typical driving time takes place with the driver's foot on neither pedal while the vehicle coasts, for example, when following behind a vehicle, easing to a stop, or going downhill. At such times, the driver may not in fact wish to slow down the vehicle, which occurs as a side effect of the regeneration process. The systems and techniques described use sensor data to infer driver intent to modulate hybrid energy by controlling when or if battery regeneration should begin, and thereby slow down the vehicle. This modification in signaling is a dynamic process, whereby the system predicts the intent of the driver each type she removes her foot from the accelerator pedal so that the hybrid system does not slow the vehicle in situations where the driver may not intend such a response, or slows the vehicle less rapidly than the hybrid system otherwise would. The result is similar (or in some cases, improved) vehicle performance accompanied by a reduced amount of combustible fuel used.

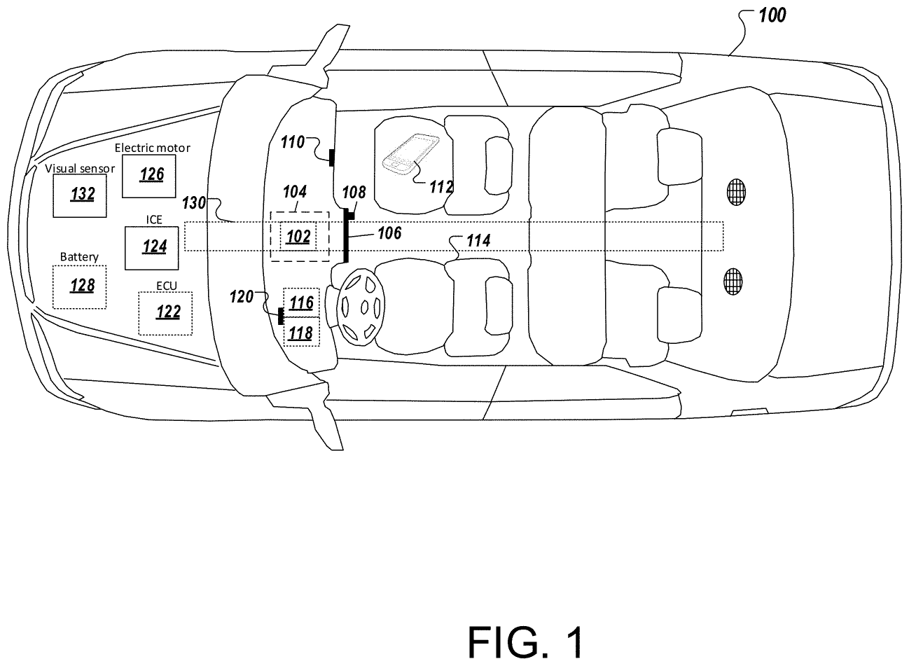

Referring to FIG. 1, alternative fuel vehicles may solely rely upon non-petroleum energy sources, such as electricity, natural gas, biofuels etc. Rather than sole reliance on such energy sources, alternative fuel vehicles may also partially rely on an internal combustion engine along with one or more alternative energy sources. For example, a vehicle (referred to as a hybrid vehicle) may use two or more distinct power sources such as an electric motor and an internal combustion engine (ICE) and is referred to as a hybrid electric vehicle (HEV). Some hybrid vehicles (referred to as plug-in hybrid vehicles) may operate by using energy storage devices that can be replenished by grid power (e.g., rechargeable batteries). For electrical energy storage devices, in some arrangements, one or more techniques may be implemented for charging and recharging the devices. For example, batteries may be charged through regenerative braking, strategic charging techniques, etc. during appropriate operating periods of the vehicle. In general, while energy is typically lost as heat in conventional braking systems, a regenerative braking system may recover this energy by using an electric generator to assist braking operations. Some systems and techniques may also strategically collect (e.g., trickle-charge) energy from the internal combustion engine during periods of efficient operation (e.g., coasting, traveling, etc.) and later assist the engine during periods of lesser efficiency. For such vehicles, the electric generator can be a device separate from the electric motor, considered as a second operating mode of the electric motor, or implemented through one or more other techniques, individually or in combination. For example, solid-state switching logic can cause a single motor to act as both a motor and a generator. Energy recovered by regenerative braking may be insufficient to provide the power needed by the vehicle. To counteract this lack of energy, the electric motor may be engaged during defined periods to assist the internal combustion engine and one or more control strategies may be used to determine these time periods. Similarly, periods of time may also be determined to engage regenerative braking and strategic charging to replenish energy storage. Other operations of the vehicle (e.g., acceleration, deceleration, gear changes, etc.) may also be defined for the control strategies. By developing such strategies to control the assistance provided to internal combustion engines (during low engine efficiency periods), energy may be conserved without negatively impacting vehicle performance.

Some vehicle manufacturers may recommend operations and control strategies for entire classes of vehicles or other types of large vehicle groups (e.g., same model vehicles, same vehicle line, etc.) at particular times (e.g., at the release of the vehicle line).

As illustrated in FIG. 1, a top view shows an example vehicle 100 (e.g., a HEV) that is able to dynamically adjust operations to improve performance through use of its electric motor. For example, by using one or more performance measures or vehicle parameters of the vehicle 100, the amount of may be dynamically adjusted during operations to improve efficiency, use of energy, fuel sources, etc. To provide this capability, the vehicle includes an assistance manager 102 (here embedded in the dashboard of the vehicle 100) that may be implemented in hardware (e.g., a controller 104), software (e.g., executable instructions residing on a computing device contained in the vehicle), a combination of hardware and software, etc. In some arrangements, the assistance manger 102 may operate in a generally autonomous manner, however, information from one or more users (e.g., identification of the vehicle operators) may be collected for operations of the assistance manager. If such input is needed, a variety of user inputs may be called upon. In this arrangement, the vehicle 100 includes an electronic display 106 that has been incorporated into its dashboard to present information such as selectable entries regarding different topics (e.g., operator ID, planned vehicle operations, trip destination, etc.). Upon selection, representative information may be gathered and provided to the assistance manager 102. In some arrangements, the gathered information may be processed by one or more computing devices (e.g., controllers) before being provided to the assistance manager 102. To interact with the electronic display 106, a knob 108 illustrates a potential control device; however, one or more other types of devices may be used for user interaction (e.g., a touch screen display, etc.). Other types of information may also be gathered; for example, a sensor 110 (here embedded in the dashboard of the vehicle 100) may collect information such as cabin temperature, location of the vehicle (e.g., the sensor being a component of a global positioning system (GPS)) and other types of information. By collecting information such as GPS location information, additional information may be provided to the assistance manager 102 (e.g., location and destination information) for determining the level that an electric motor 126 should assist the internal combustion engine 124 or ICE 124 (e.g., by providing torque to the vehicle's driveshaft 130, shown highly schematically).

In some arrangements, information from other vehicles may be used by the assistance manager 102. For example, data may be collected from a fleet of vehicles (e.g., similar or dissimilar to the vehicle 100) and used to determine the amount of battery regeneration (e.g., based on similarly traveled routes).

One or more devices present in the vehicle 100 may also be used for information collection; for example, handheld devices (e.g., a smart phone 112, etc.) may collect and provide information (e.g., location information, identify individuals present in the vehicle such as vehicle operators, etc.) for use by the assistance manager 102 (e.g., identify driving characteristics of a vehicle operator). Similarly, portions of the vehicle itself (e.g., vehicle components) may collect information for the assistance manager 102; for example, one or more of the seats of the vehicle 100 (e.g., driver seat 114) may collect information (e.g., position of the seat to estimate the driver's weight) for being provided to the assistance manager 102.

Multiple sensors may be located internally or externally to the vehicle for collecting information. For example, a pedal position sensor 120 may detect the position of the vehicle's brake pedal 116 and the position of the vehicle's accelerator pedal 118. The pedal position sensor 120 is one of many sensors that are typically used by an engine control unit 122 (ECU). The ECU employs software to determine the required throttle signal of the internal combustion engine 124 by calculations from data measured by the pedal position sensor 120 and additional sensors 110 (e.g., an engine speed sensor, a vehicle speed sensor, cruise control switches). The ECU calculates how much to increase the amount of fuel being provided to the internal combustion engine 124 based on a voltage signal indicating how far and quickly the accelerator pedal 118 is pressed.

The sensors can include a visual sensor 132. The visual sensor 132 can be one or more visual cameras capable of video capture, or an image capture device that collects still images at periodic intervals (e.g., every half second). Additionally and alternatively, the visual sensor 132 can be supplemented with sensors having non-visual features, for example LIDAR, radar, ultrasonic, or stereo-visual capability. The visual sensor 132 can be positioned at any convenient location on the forward potion of the vehicle, for example behind the rear-review mirror.

To make determinations about driver intent based on visual feedback, operational information may also be collected. For example, one or more performance measures such as instantaneous miles-per-gallon (instantaneous MPG), fuel consumption rate (e.g., gallons per hour), current speed, acceleration, etc. may be collected by the various sensors 110. Information regarding the alternative fuel based system may also be collected, for example, the current state of the alternative fuel source such as a measure of the amount of energy stored in one or more storage devices, e.g., a battery 128 residing on the vehicle. Based upon the type of alternative fuel being used by the vehicle, other measures may be provided; for example, chemical levels, natural gas levels, biofuel levels, hydraulic pressure, etc. may be used by the assistance manager 102.

The assistance manager 102 may also take part in providing an interface to components of the vehicle 100. For example, when the regeneration profile to be employed is quantified, the assistance manager 102 may also function as an interface with components of the vehicle 100. For example, one or more quantities associated with a determined regeneration profile may be provided to appropriate components of the vehicle (e.g., interface modules, circuitry, etc. for controlling the operations of the internal combustion engine 124, the electric motor 126, the battery 128, etc.).

In some arrangements, remotely located information sources may be accessed by the vehicle. Similarly, some or all of the functionality of the assistance manager 102 may be provided from a remote location. While illustrated in the figure as residing onboard the vehicle 100, in some arrangements, the assistance manager 102 or a portion of the assistance manager may be located and executed at one or more other locations. In such situations, one or more communication techniques and methodologies may be implemented for the vehicle 100 to be provided assistance from a remotely located assistance manger. For example, one or more wireless communication techniques (e.g., radio frequency, infrared, etc.) may be utilized that call upon one or more protocols and/or standards (e.g., the IEEE 802.11 family of standards such as Wi-Fi, the International Mobile Telecommunications-2000 (IMT-2000) specifications such as 3rd generation mobile telecommunications (3G), 4th generation cellular wireless standards (4G), 5^{th} generation wireless broadband technology (5G), wireless technology standards for exchanging data over relatively short distances such as Bluetooth, etc.).

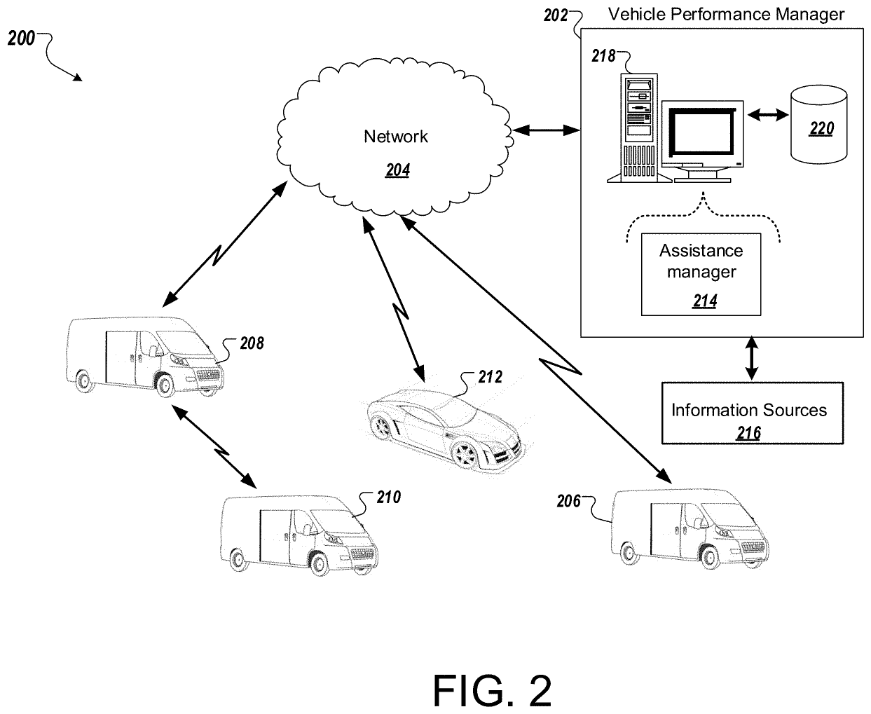

Referring to FIG. 2, an information exchanging environment 200 is presented that allows information to be provided from a central location for assisting hybrid electric vehicles. In some arrangements, the information is collected from vehicles or other information sources for determining the regeneration profile to provide to a battery 128 (shown in FIG. 1). One or more techniques and methodologies may be implemented for providing such information to the vehicles. For example, one or more communication techniques and network architectures may be used for exchanging information. In the illustrated example a vehicle performance manager 202 communicates through a network 204 (e.g., the Internet, an intranet, a combination of networks, etc.) to exchange information with a collection of vehicles (e.g., a fleet of supply trucks 206, 208, 210, and an automobile 212). In some arrangements the network architecture 204 may be considered as including one or more of the vehicles. For example, vehicles may include equipment for providing one or more network nodes (e.g., supply truck 208 functions as a node for exchanging information between the supply truck 210 and the network 204). As such, the information exchanging capability may include the vehicles exchanging information with the vehicle performance manager 202 and other potential network components (e.g., other vehicles, etc.).

One or more technologies may be used for exchanging information among the vehicle performance manager 202, the network 204 (or networks) and the collection of vehicles. For example, wireless technology (capable of two-way communication) may be incorporated into the vehicles for exchanging information with the vehicle performance manager 202. Along with providing and collecting information from the vehicles, the vehicle performance manger 202 may be capable of processing information (e.g., in concert with an assistance manger 214 to determine a regeneration profile) and executing related operations (e.g., store collected and processed information). In some arrangements, the vehicle performance manager 202 may operate as a single entity; however, operations may be distributed among various entities to provide the functionality. In some arrangements, some functionality (e.g., operations of the assistance manger 214) may be considered a service, rather than a product, and may be attained by entering into a relationship with the vehicle performance manager 202 (e.g., purchase a subscription, enter into a contractual agreement, etc.). As such, the vehicle performance manager 202 may be considered as being implemented as a cloud computing architecture in which its functionality is perceived by clients (e.g., vehicle operators) as a service rather than a product. For such arrangements, vehicles may be provided information (e.g., quantities that represent amounts of torque that an electric motor should provide to assist a corresponding internal combustion engine) from one or more shared resources (e.g., hardware, software, etc.) used by the vehicle performance manager 202. For service compensation, one or more techniques may be utilized; for example, subscription plans for various time periods may be implemented (e.g., a monthly subscription fee for updates to regeneration profile protocols and operating recommendations should be provided to identified vehicles).

Similar to an onboard assistance manger (e.g., the assistance manager 102 of FIG. 1), an off-vehicle assistance manager (e.g., the assistance manager 214) may use one or more quantities from a vehicle (e.g., data provided from visual sensors, etc.) to determine the optimal regeneration profile for fuel management in a particular instance. In some arrangements, quantities may also be based upon vehicle components and component operation (e.g., transmission shift points based upon engine revolutions per minute (rpm), load effects, engine torque output based on position of the accelerator pedal, etc.). In some arrangements, user-associated information (e.g., historical driving characteristics of an operator) may be used for defining the regeneration profile for implementation by the assistance manager 214.

One or more types of regeneration profiles, rules for implementing different regeneration profiles, etc. may be defined for use by the assistance manager 214 (or the onboard assistance manager 102). In some arrangements the regeneration profile may be defined as a percentage that represents the amount of energy that the electric motor 126 should provide to the battery 128 from the default (e.g., maximum) amount of energy available (e.g., 100% to allow immediate and complete regeneration per the default setting, 0% to allow no regeneration to begin). The regeneration profile may also be defined as an increasing or decreasing value, e.g., the amount of regeneration increases or decreases over a time interval. To determine such assistance, one or more quantities originating with the vehicle may be used by the assistance manager (e.g., the onboard assistance manager 102, the off board assistance manager 214). For example, a measure of available energy may reflect the alternative fuel system's ability to assist. For the electric motor based system, the state of charge (SOC) of the battery 128 (or batteries) onboard the vehicle may provide such a measure. Information from the internal combustion engine 124 of the vehicle may also be used to determine the assistance percentage. For example, a performance measure of the internal combustion engine such as the instantaneous MPG of the vehicle may be utilized. Such a performance measure may be provided by other quantities, for example, vehicle speed, the position of one or more of the vehicle's pedals (e.g., the accelerator pedal position, brake pedal position, etc.), data that represents collecting energy (e.g., regenerative braking, strategic charging, leeching, etc.) to replenish energy storage (e.g., charging, recharging vehicle batteries, etc.).

In one arrangement, monitoring the capability of the alternative fuel system (e.g., the current state of charge of the battery or batteries which are high voltage batteries) may be used to define and dynamically adjust the amount of assistance needed. For example, if the state of charge of the battery (or batteries) of the vehicle is above a predefined or threshold value (e.g., 80% of the total battery pack capacity), a weak regeneration profile may be provided by the electric motor 126. In the alternative situation, if the state of charge of the vehicle battery 128 is below the predefined value, the regeneration profile may be aggressive (e.g., the amount of energy provided to the battery 128 may be high to restore battery charge).

Along with information being provided by one or more vehicles (e.g., received onboard, received through the network 204, etc.), the vehicle performance manager 202 may utilize data from other sources to improve alternative fuel use, identify fuel-saving opportunities, etc. For example, information sources 216 external to the vehicle performance manager 202 may provide vehicle related information (e.g., manufacture recommendations for battery state of charge, vehicle load conditions, etc.), environmental information (e.g., current road conditions where the vehicle is operating, traffic conditions, topographical information, weather conditions and forecasts, etc.). In some arrangements, the information sources 216 may be in direct communication with the vehicle performance manager 202; however, other communication techniques may also be implemented (e.g., information from the information sources 216 may be provided through one or more networks such as network 204).

To select and define the regeneration profile for attempting to minimize the use of combustible fuel, one or more types of information may be utilized. For example, various types of information may be used to define an appropriate state of charge (e.g., 80% charge), and a performance measure for the vehicle (e.g., 5 mph), etc. may be determined from a variety of information sources. For example, historical information regarding operations of the vehicle (e.g., typical MPG provided by the vehicle during operation), the vehicle operator (e.g., average driving speed of the operator), etc. may factor into quantity selection. Sensor information (e.g., from embedded vehicle sensors, sensing device present in the vehicle, etc.) may also provide information such as vehicle weight, road grade, temperature, etc. that is used to analyze the vehicle's activity and develop the quantities. For example, delivery trucks that generally travel between cities or through rural routes may have a pattern of highway driving (e.g., coasting behind vehicles with infrequent braking for the purpose of stopping). Appropriate rules may be implemented, such as directing the electric motor 126 to never begin regeneration when the vehicle is above a certain speed (e.g., highways speeds such as 50 mph). In another example, vehicles such as urban delivery vans may frequently be driven in similar manners (e.g., similar driving pattern, operating hours, routes, mileage, cargo being hauled, mannerisms of the drivers, etc.) that may also be represented in the analysis. Such a stop-and-go pattern with frequent braking for deliveries and city traffic may be assisted with rules such as always directing the electric motor 126 to maximize regeneration (and hence assist in slowing the vehicle).

From relatively current information (e.g., data provided near real time) and previously collected information (e.g., historical data for a vehicle, a fleet of similar vehicles, etc.), the assistance manager 214 may analyze and produce the quantities for determining the regeneration profile needed. For example, quantities may be determined for an individual vehicle that accounts for data associated with the vehicle and information that accounts for historical patterns of similar vehicles, vehicles operating under similar conditions, etc. Since a fleet of similar vehicles would typically produce larger amounts of information, compared to information generated by a single vehicle, quantities for assistance strategies based upon multiple vehicles (e.g., vehicles operating under similar environmental conditions, vehicles operating in the same general geographical area, the entire vehicle fleet, etc.) may provide more appropriate quantities for determining the regeneration profile for efficient use of both the alternative fuel system and the internal combustion engine, for example.

In the illustrated example, to provide assistance functionality, the vehicle performance manager 202 includes a server 218 that is capable of being provided information from the network 204 and the information sources 216. Additionally, the server 218 is illustrated as being in direct communication with a storage device 220 that is located at the vehicle performance manager 202. In this example of the assistance manager 214 being off board a vehicle, in comparison to the assistance manager 102 (of FIG. 1), the assistance manager 214 is executed by the server 218. Provided information from one or more of the sources, quantities and the regeneration profile may be developed by the assistance manager 214. Along with determining an appropriate regeneration profile for balancing the use of the alternative fuel, the assistance manager 214 may appropriately manage the distribution of the determined quantities and the regeneration profile for delivery to one or more corresponding vehicles. For example, one or more database systems, data management architectures, communication schemes may be utilized by the assistance manager 214 for information distribution. In some arrangements, such distribution functionality may be provided partially or fully by the assistance manger 214 or external to the assistance manager. In some arrangements this distribution functionality may be provided by other portions of the vehicle performance manager 202 or provided by another entity separate from the performance manager for distributing the regeneration profile and/or other types of information. Further, while a single server (e.g., server 218) is implemented in this arrangement to provide the functionality for the vehicle performance manager 202, additional servers or other types of computing devices may be used to provide the functionality. For example, operations of the assistance manager 214 may be distributed among multiple computing devices located at one or more locations.

Upon one or more quantities and the regeneration profile being produced, one or more operations may be executed to provide appropriate information to one or more vehicles. For example, operations of a computing device (e.g., the server 218) located at the vehicle performance manager 202 may provide the information to the appropriate vehicle (or vehicles). By using one or more wireless links the information may be delivered (e.g., through the network 204). In some arrangements one or more trigger events may initiate the information being sent to a vehicle. For example, upon one or more messages, signals, etc. being received at the vehicle performance manager 202 (e.g., that an identified operator has begun driving a particular hybrid vehicle), data representing the appropriate regeneration strategy may be provided to the vehicle. For arrangements in which the analysis is executed onboard the vehicle, quantities associated with a regeneration strategy may be identified onboard (e.g., by the assistance manager 102) and provided to appropriate components of the vehicle. In still other arrangements, one or more strategies could be manually loaded onto a vehicle—for example a vehicle could be preloaded with regeneration strategy specific to typical routes, have multiple driver-selectable strategies loaded, etc. Along with providing strategies, updated data may similarly be sent to vehicles to make needed adjustments to previously provided strategies (e.g., adjust initial quantities, update the regeneration profile, provide performance limitation metrics, toggle on/off the assistance manager 102, etc.). Adjustments to provided strategies may also be adjusted after delivery to the vehicle. For example, one or more components included in the vehicles may monitor the strategies (e.g., using artificial intelligence techniques, neural networks, etc.) and make appropriate adjustments (e.g., goal state of charge, the regeneration profile) for an electric motor, etc. of the vehicle.

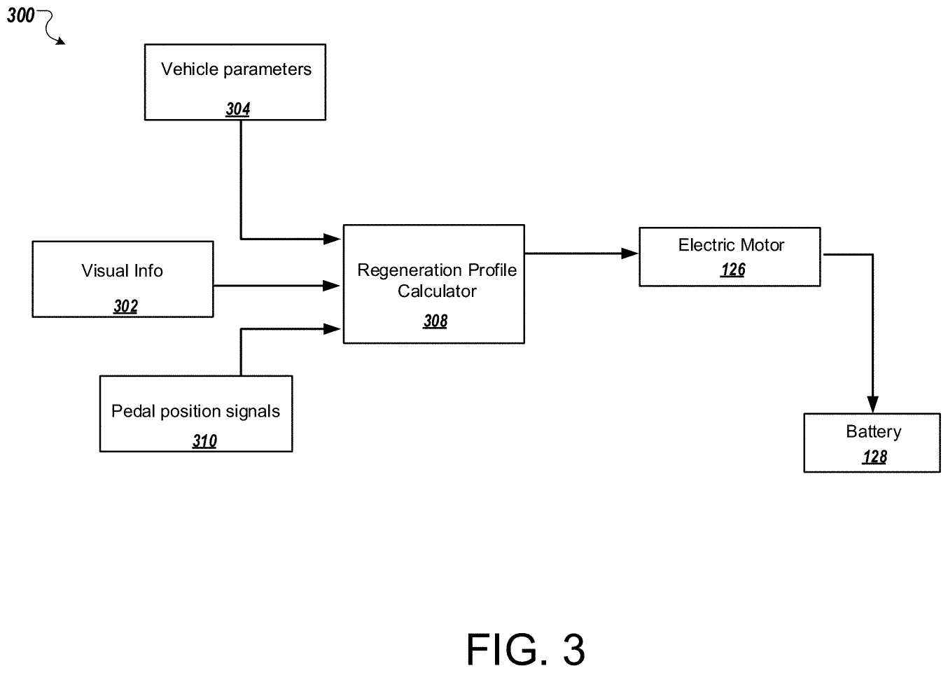

Referring to FIG. 3, a system level diagram 300 presents one arrangement for responding to a user's pedal command in a hybrid electric system by determining and adjusting the regeneration profile that the electric motor 126 uses to recharge the battery 128. In general, the diagram 300 presents operational functions of an assistance manager (e.g., the onboard assistance manager 102 of FIG. 1, the off board assistance manager 214 of FIG. 2, etc.) with associated hardware, a combination of onboard and off board managers, etc. The assistance manager 102 modulates the regeneration profile generated by receiving or intercepting the pedal request, receiving visual data about the vehicle's environment and vehicle parameters such as speed, then deciding on the best regeneration profile to use in the current vehicle situation, and sending a signal to the electric motor 126 to regenerate the battery 128 (or not regenerate the battery 128) in accordance with the profile. The end result is the vehicle subsequently performs in accordance with the inferred intent of the driver, reducing the amount of combustible fuel used.

As shown in the diagram 300, a regeneration profile calculator 308 calculates battery regeneration for a particular driving scenario in response to signals received from the various vehicle sensors. These signals include visual information 302 (e.g., imagery from visual sensor 132). The visual information 302 includes information about the environment around the vehicle 100 (e.g., objects in front of the vehicle in its travel path).

The regeneration profile calculator 308 also receives a pedal position signal 310 from the vehicle. The one or more sensors located onboard the vehicle (e.g., pedal position sensor 120 in FIG. 1) provide data or signals representative of the pedal position 310 (e.g., voltage signals). In some arrangements, the pedal position 310 signal may be defined as a percentage of the maximum pedal position (e.g., the pedal is pressed 0%, 25%, 100%) of the operator stepping on the pedal.

Additionally, the regeneration profile calculator 308 also receives signals representing various vehicle parameters 304 from the vehicle 100. These can include characteristics of the vehicle's structure and operation, such as its transmission, the size of the battery, the driver's driving pattern, state of charge of battery, maximum state of charge of battery, the vehicle platform, current vehicle speed, details of an anti-lock braking system, traction control system state, steering patterns, temperatures, wheel speeds etc. One or more sensors located onboard the vehicle (e.g., sensors 110 in FIG. 1) provide data or signals representative of these data.

The regeneration profile calculator 308 determines the regeneration profile to be provided to the electric motor 126. In this arrangement, the regeneration profile calculator 308 uses the received vehicle parameters 304, visual information 302, and pedal positions 310 from the vehicle to make the calculation. In general, the regeneration profile calculator 308 may implement one or more techniques and methodologies to determine the regeneration profile that the vehicle's electric motor 126 should carry out. For example, using the provided quantities (the pedal position 310, visual information 302, and vehicle parameters 304), the regeneration profile may be determined by using one or more techniques (e.g., one or more mathematical functions such as linear functions that map the pedal position 310 to an regeneration profile, using one or more look-up tables, e.g., to determine an the regeneration profile from the performance measure, utilizing other types of numerical relationships, etc.). The regeneration profile calculator also may employ various image processing techniques to analyze the visual information 302 (e.g., smoothing, object identification, filtering, edge detection, determination of distance and speed of objects, etc.).

In some instances, the image processing involves reading video images and performing both pattern matching and distance estimation. The pattern matching looks for traffic signals, like traffic lights and stop signs and the color of the traffic signal (red, yellow, or green). The image processing identifies these objects to determine if it is likely that the driver intends to stop. The image processing also identifies the back of vehicles and the distance to the nearest vehicle in front. The system matches typical references of the rear of a vehicle like glass, tail lights, and license plates to determine the presence of a vehicle. It uses the size of these objects or triangulation to determine the distance to the vehicle. By monitoring the distance to the vehicle in front, the system determines if the driver needs to slow down or drive at a steady speed, aiding the system in determining driver intent and need for braking. In some instances, the image processing techniques include deep learning and neural network techniques.

Along with providing the regeneration profile used to adjust the operations of the electric motor 126, the determined quantities can also be used for further processing and other operations. For example, one or more feedback schemes may be implemented such that the regeneration profile is used for determining future regeneration profiles or other quantities to improve use of the alternative fuel system and efficiency of operations of the vehicle.

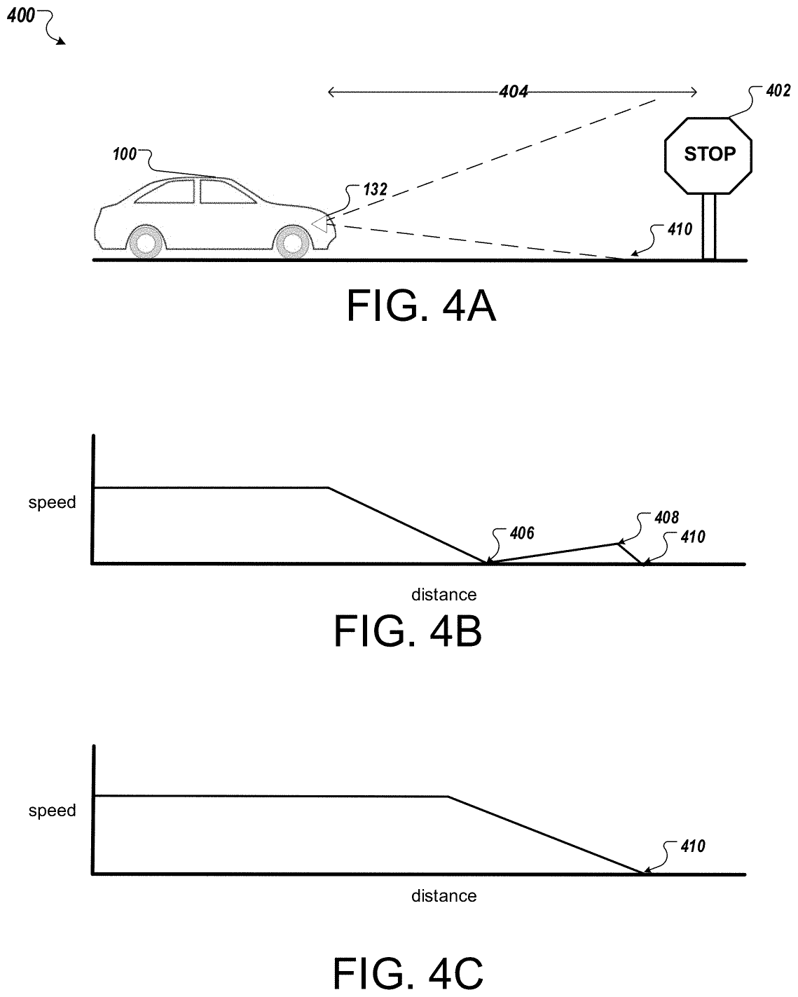

FIG. 4A depicts a typical driving scenario that a driver of the vehicle 100 may encounter, approaching an object of interest 402, in this case a stop sign. The object of interest 402 may be other objects than a stop sign, such as a stop light, a blinking traffic signal light, a pedestrian, another vehicle, or obstruction such as a barrier, wall, or fence. As the vehicle is travelling forward, the driver sees the stop sign 402. The visual sensors 132 mounted on the front of the vehicle also detect the stop sign as an object of interest 402. Using visual image analysis, the assistance manager 102 identifies the object of interest 402 as a stop sign, an indicator that the driver will likely wish to slow down and stop the vehicle in the immediate future. The classification of the image and identification of a stop sign can occur as a function of the regeneration profile calculator 308, or be part of a separate system that passes the identifier to the regeneration profile calculator as part of the visual information 302. The assistance manager 102 also calculates the separation distance 404 between the vehicle 100 and the stop sign 402. The calculation may include a stopping location 410 relative to the stop sign (e.g., a standard distance between a stop sign and the stop line). The calculation may also include the velocity and the acceleration of the vehicle 100 relative to the stop sign 402 or to the stopping location 410.

FIG. 4B represents a typical speed vs. distance profile of a vehicle in the scenario of FIG. 4A without assistance from an assistance manager. When the driver is at a reasonable distance where many drivers begin slowing down for the stop sign, e.g., distance 404 in FIG. 4A, he removes his foot from the accelerator pedal. In traditional systems, regenerative breaking begins immediately and seeks to maximize the battery charge. This can decelerate the vehicle too quickly, causing the vehicle to come to a premature stop at position 406. The driver must then press the accelerator pedal 118 and burn more fuel until position 408 where he typically removes his foot from the accelerator pedal 118 and may need to press the brake pedal 116 to come to a complete stop at desired position 410. This depicts the undesirable scenario of fighting the engine, e.g., slowing the vehicle too rapidly, causing the driver use more fuel by hitting the accelerator again to make the car do what the driver originally intended.

In FIG. 4C the regeneration profile calculator 308 determines how to slow down the vehicle using battery regeneration without the driver needing to tap the break at the intersection, by inferring the driver's intent. The regeneration profile calculator 308 knows the distance 404 to the stop sign 402, and knows that the stop sign 402 indicates that the driver likely does intend to slow the vehicle when he removes his foot from the accelerator pedal 118. The assistance manager 102 can therefore permit regeneration of the battery 128 and cause the vehicle 100 to slow. The regeneration profile calculator 308 can modify the regeneration profile that the electric motor 126 carries out. As the system has the current speed as part of the vehicle parameters 304, the regeneration profile calculator 308 can determine what deceleration to apply to bring the vehicle 100 to a halt at the point 410, and not prematurely. The regeneration profile calculator 308 sends a signal to the electric motor 126 to regenerate the battery 128 at a rate that causes the vehicle 100 to slow down according the calculated deceleration. The vehicle 100 thus comes to a rest at stopping location 410, usefully regenerating the battery 128 and with zero fuel used.

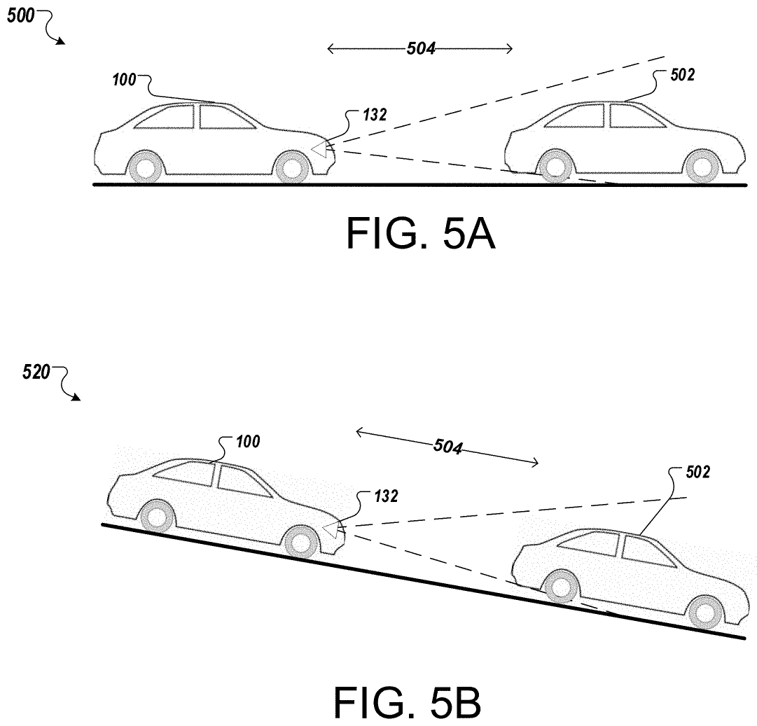

FIG. 5A depicts another typical driving scenario 500 that a driver of the vehicle 100 may encounter, that of following a leading vehicle 502 either on the highway or on city streets. The visual sensor 132 mounted on the front of the vehicle detects the leading vehicle as an object of interest. Using visual image analysis, the assistance manager 102 identifies the object of interest as a leading vehicle 502. In this instance, identification of the object as a leading vehicle 502 is not a clear indicator whether or not the driver will wish to slow down or to stop the vehicle in the immediate future when he removes his foot from the brake. The driver may wish to coast and only take advantage of the slight slowing that occurs in any vehicle when the accelerator pedal is depressed. Alternatively, the driver may indeed wish to slow down to a stop.

To make a determination, the assistance manager 102 calculates the separation distance 504 between the vehicle 100 and the leading vehicle 502. The calculation may also include the velocity and the acceleration of the vehicle 100 relative to the leading vehicle 502. In some instances, the profile regeneration calculator 308 compares the acceleration and velocity determined from visual information 302 to the acceleration and velocity being fed as part of the vehicle parameters 304 and/or the pedal position signals 310. If the system determines that the distance 504 between the vehicle 100 and the leading vehicle 502 is relatively constant or increasing, then the profile regeneration calculator 308 will signal the electric motor 126 to not regenerate the battery, or to allow only a small amount of regeneration. The profile regeneration calculator 308 infers that the driver does not intend to slow down from the determination that the vehicle 100 is following another vehicle 502 and is not catching up to it. If the system determines that the distance 504 between the vehicle 100 and the leading vehicle 502 is decreasing, the profile regeneration calculator 308 will determine that the driver likely does intend to slow the vehicle 100. The profile regeneration calculator 308 will send a regeneration signal to the electric motor 126 to begin regeneration, and turn the deceleration the driver desires into stored battery energy rather than using the mechanical brakes. In some instances, the profile regeneration calculator 308 will modulate the regeneration profile to keep a constant distance 504 between the vehicle and the leading vehicle 502.

FIG. 5B shows another driving scenario 520, similar to that of FIG. 5A. The assistance manager 102 has identified a leading vehicle 502. Other sensors 110 on the vehicle 100 also inform the profile regeneration calculator 308 that the vehicle 100 is travelling on a downwards slope. If the system determines that the distance 504 between the vehicle 100 and the leading vehicle 502 is decreasing, the profile regeneration calculator 308 determines that the driver likely does intend to slow the vehicle 100. The profile regeneration calculator 308 will send a regeneration signal to the electric motor 126 to carry out a higher amount of regeneration than in FIG. 5A as the braking must work against gravity as well. The profile regeneration calculator 308 can account for the slope of travel in other instances as well. For example, if the visual sensor 132 detects a stop sign, the profile regeneration calculator 308 may send a stronger regeneration signal than otherwise to account for the gravity.

Other driving scenarios are also possible. For example, the visual sensors 132 may detect a leading vehicle that is slowing down so that the profile regeneration calculator 308 sends a signal to carry out regeneration. Additionally, the visual sensors 132 may detect a stop sign further ahead. The profile regeneration calculator 308 may send a stronger regeneration signal than just for a slowing leading vehicle on the assumption that the driver of the vehicle 100 will be slowing not only due to the leading vehicle, but coming to a stop at the stop sign. The profile regeneration calculator 308 may include a greater stopping distance allowance than if just a stop sign is detected, to account for the presence of the leading vehicle stopping ahead of the vehicle 100.

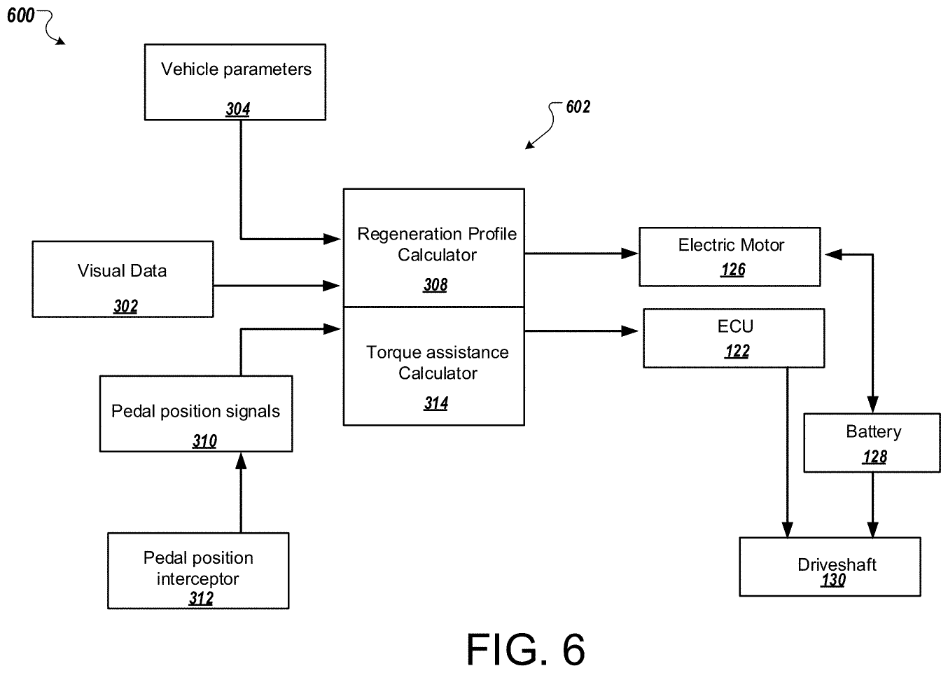

Referring to FIG. 6 an alternative system level diagram 600 includes the capability of intercepting the pedal position signal for the accelerator pedal. Details of such a system and methods of using it are also described in an application filed the same day as the instant application by the same applicant and with the same inventors. Briefly, the position of the accelerator pedal 118 and/or the brake pedal 116 read by the pedal position sensor 120 present in the vehicle 100 (FIG. 1) is intercepted by a pedal position interceptor 312 placed between the pedals and the ECU 122. A torque assistance calculator 314 modifies the signal sent to the ECU 122 (e.g., by modifying a voltage of the pedal position signal 310 and sending the modified voltage signal to the ECU 122). Generally, the ECU 122 determines the amount to increase fuel input to the internal combustion engine 124 in accordance with the modified voltage signal. The amount to increase the fuel input is based on how far the acceleration pedal appears to have been pressed by the user (e.g., the signal determined by the pedal position sensor 120). However, the voltage signal passed to the ECU 122 by the torque assistance calculator is modified, and the ECU 122 calculates a different (e.g., lower) amount to increase fuel injection into the engine (e.g., provide torque to the driveshaft 130 from the ICE 124) in favor of the electric motor 126 providing torque to the driveshaft 130.

System 600 can achieve additional functionality by modulating the accelerator pedal position based on environmental changes detected by the visual sensors 132. In the scenario shown in FIG. 5A, the vehicle 100 is following the leading vehicle 502. The assistance manager 602 may determine the distance to the leading vehicle 502, and the maximum acceleration required to close to standard following distance. As the assistance manager 602 controls the regeneration profile and the amount of torque assistance, the assistance manager may prevent a driver from over-accelerating when following a car in traffic by limiting the accelerator signal passed through to the driveshaft 130, or by sending a regeneration signal to the electric motor to begin regeneration and slightly slow the vehicle, or both. The system 600 can act to reduce fighting (e.g., minimize) between the accelerator and brake signals.

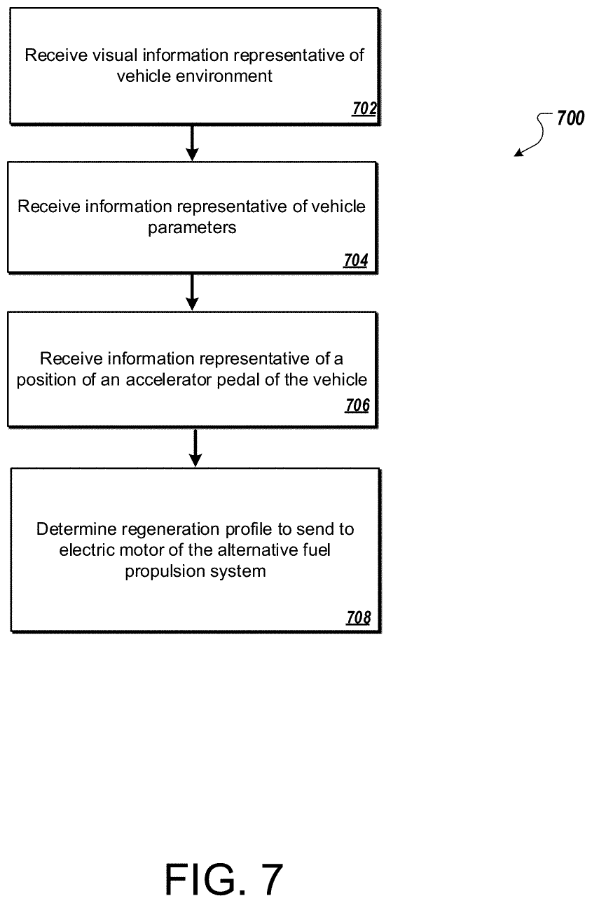

Referring to FIG. 7, a flowchart 700 that represents operations for controlling a hybrid vehicle is described. At step 702 the assistance manager receives visual information representative of the environment forward of a travelling vehicle that includes an alternative fuel propulsion system. For example, the assistance manager 102 in FIG. 1 can receive visual information from visual sensor 132. At step 704 the assistance manager receives information representative of vehicle parameters for a given period of time and at step 706 receives information representative of a position of an accelerator pedal of the vehicle. For example, the assistance manager 102 in FIG. 1 can receive information from the pedal sensor 120 and additional sensors 110. At step 708 the manager determines a regeneration profile to send to an electric motor of the vehicle. This is determined from the visual information received and from the information representative of a position of a pedal received and the regeneration profile assistance required to send to the electric motor of the alternative fuel propulsion system included in the vehicle.

The signal modification produced by the assistance manager 102 is not static. Rather, the signal modification is a system that adapts the signals sent to the electric motor depending on visual data monitored by the hybrid system.

In some instances, field tuning can smooth out some bad driving habits. For example, some drivers heavily modulate the pedal at steady speed (unnecessarily speeding up and slowing down around the average driving speed). These actions are small variations in accelerator pedal position. The systems described can intercept those variations in the accelerator signal and cause the electric motor to provide much of that positive and negative torque, or cause the electric motor to provide a reduced amount of regeneration, thereby saving gas.

In some instances, the regeneration profile calculator 308 can assist an inattentive driver. If the visual sensors 132 detect an obstacle such as a pedestrian and no signal that the driver has removed his foot from the accelerator pedal 118, the regeneration profile calculator 308 may start maximum regeneration to slow the vehicle and give the driver time to notice the pedestrian.

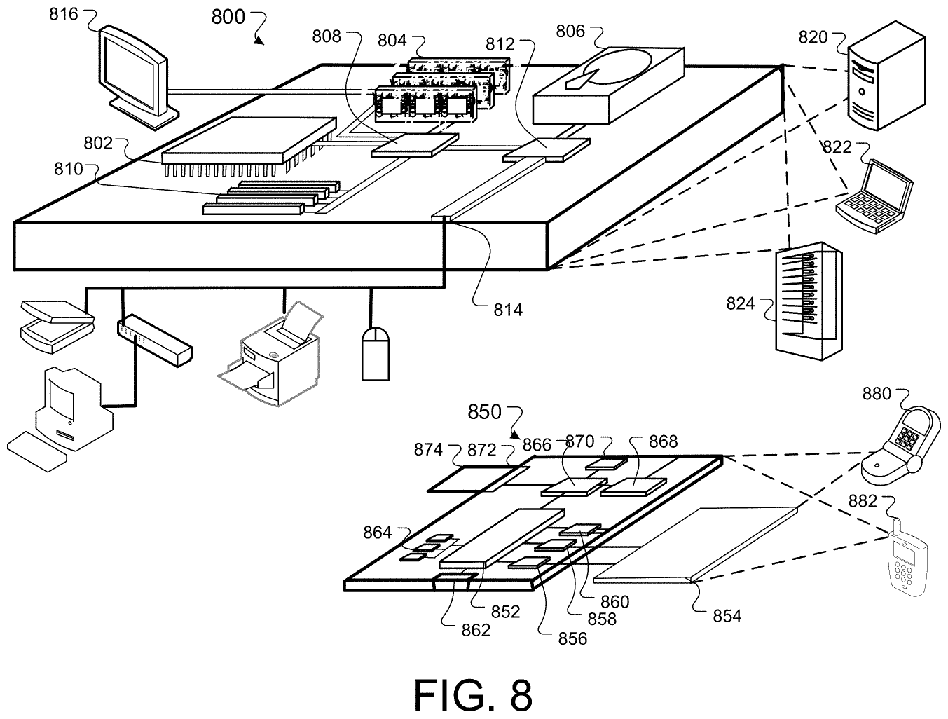

FIG. 8 shows an example of example computer device 800 and example mobile computer device 850, which can be used to implement the techniques described herein. For example, a portion or all of the operations of an assistance manager (e.g., the assistance manger 102 shown in FIG. 1, the assistance manager 214 shown in FIG. 2, etc.) may be executed by the computer device 800 and/or the mobile computer device 850. Computing device 800 is intended to represent various forms of digital computers, including, e.g., laptops, desktops, workstations, personal digital assistants, servers, blade servers, mainframes, and other appropriate computers. Computing device 850 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 800 includes processor 802, memory 804, storage device 806, high-speed interface 808 connecting to memory 804 and high-speed expansion ports 810, and low speed interface 812 connecting to low speed bus 814 and storage device 806. Each of components 802, 804, 806, 808, 810, and 812, are interconnected using various busses, and can be mounted on a common motherboard or in other manners as appropriate. Processor 802 can process instructions for execution within computing device 800, including instructions stored in memory 804 or on storage device 806 to display graphical data for a GUI on an external input/output device, including, e.g., display 816 coupled to high speed interface 808. In other implementations, multiple processors and/or multiple buses can be used, as appropriate, along with multiple memories and types of memory. Also, multiple computing devices 800 can be connected, with each device providing portions of the necessary operations (e.g., as a server bank, a group of blade servers, or a multi-processor system).

Memory 804 stores data within computing device 800. In one implementation, memory 804 is a volatile memory unit or units. In another implementation, memory 804 is a non-volatile memory unit or units. Memory 804 also can be another form of computer-readable medium, including, e.g., a magnetic or optical disk.

Storage device 806 is capable of providing mass storage for computing device 800. In one implementation, storage device 806 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 804, storage device 806, memory on processor 802, and the like.

High-speed controller 808 manages bandwidth-intensive operations for computing device 800, while low speed controller 812 manages lower bandwidth-intensive operations. Such allocation of functions is an example only. In one implementation, high-speed controller 808 is coupled to memory 804, display 816 (e.g., through a graphics processor or accelerator), and to high-speed expansion ports 810, which can accept various expansion cards (not shown). In the implementation, low-speed controller 812 is coupled to storage device 806 and low-speed expansion port 814. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 800 can be implemented in a number of different forms, as shown in the figure. For example, it can be implemented as standard server 820, or multiple times in a group of such servers. It also can be implemented as part of rack server system 824. In addition or as an alternative, it can be implemented in a personal computer including, e.g., laptop computer 822. In some examples, components from computing device 800 can be combined with other components in a mobile device (not shown), including, e.g., device 850. Each of such devices can contain one or more of computing device 800, 850, and an entire system can be made up of multiple computing devices 800, 850 communicating with each other.

Computing device 850 includes processor 852, memory 864, an input/output device including, e.g., display 854, communication interface 866, and transceiver 868, among other components. Device 850 also can be provided with a storage device, including, e.g., a microdrive or other device, to provide additional storage. Each of components 850, 852, 864, 854, 866, and 868, are interconnected using various buses, and several of the components can be mounted on a common motherboard or in other manners as appropriate.

Processor 852 can execute instructions within computing device 850, including instructions stored in memory 864. The processor can be implemented as a chipset of chips that include separate and multiple analog and digital processors. The processor can provide, for example, for coordination of the other components of device 850, including, e.g., control of user interfaces, applications run by device 850, and wireless communication by device 850.

Processor 852 can communicate with a user through control interface 858 and display interface 856 coupled to display 854. Display 854 can be, for example, a TFT LCD (Thin-Film-Transistor Liquid Crystal Display) or an OLED (Organic Light Emitting Diode) display, or other appropriate display technology. Display interface 856 can comprise appropriate circuitry for driving display 854 to present graphical and other data to a user. Control interface 858 can receive commands from a user and convert them for submission to processor 852. In addition, external interface 862 can communicate with processor 842, so as to enable near area communication of device 850 with other devices. External interface 862 can provide, for example, for wired communication in some implementations, or for wireless communication in other implementations, and multiple interfaces also can be used.

Memory 864 stores data within computing device 850. Memory 864 can be implemented as one or more of a computer-readable medium or media, a volatile memory unit or units, or a non-volatile memory unit or units. Expansion memory 874 also can be provided and connected to device 850 through expansion interface 872, which can include, for example, a SIMM (Single In Line Memory Module) card interface. Such expansion memory 874 can provide extra storage space for device 850, or also can store applications or other data for device 850. Specifically, expansion memory 874 can include instructions to carry out or supplement the processes described above, and can include secure data also. Thus, for example, expansion memory 874 can be provided as a security module for device 850, and can be programmed with instructions that permit secure use of device 850. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 864, expansion memory 874, and/or memory on processor 852, which can be received, for example, over transceiver 868 or external interface 862.

Device 850 can communicate wirelessly through communication interface 866, which can include digital signal processing circuitry where necessary. Communication interface 866 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 868. In addition, short-range communication can occur, including, e.g., using a Bluetooth®, Wi-Fi, or other such transceiver (not shown). In addition, GPS (Global Positioning System) receiver module 870 can provide additional navigation- and location-related wireless data to device 850, which can be used as appropriate by applications running on device 850.

Device 850 also can communicate audibly using audio codec 860, which can receive spoken data from a user and convert it to usable digital data. Audio codec 860 can likewise generate audible sound for a user, including, e.g., through a speaker, e.g., in a handset of device 850. Such sound can include sound from voice telephone calls, can include recorded sound (e.g., voice messages, music files, and the like) and also can include sound generated by applications operating on device 850.

Computing device 850 can be implemented in a number of different forms, as shown in the figure. For example, it can be implemented as cellular telephone 880. It also can be implemented as part of smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device-implemented method comprising:
receiving information representative of an environment forward of a travelling vehicle that includes an alternative fuel propulsion system;
receiving information representative of a vehicle performance measure;
receiving information representative of a position of an accelerator pedal of the vehicle; and
determining a battery regeneration profile to send to an electric motor of the alternative fuel propulsion system of the vehicle from the received information representative of the position of a pedal, the received information representative of the vehicle performance measure, and received information representative of the environment.

2. The computing device-implemented method of claim 1, wherein the performance measure represents a speed of the vehicle.

3. The computing device-implemented method of claim 1, wherein the information representative of the environment is camera images of a road segment in front of the vehicle.

4. The computing device-implemented method of claim 3, comprising detecting an object of interest from the camera images.

5. The computing device-implemented method of claim 4, wherein the object of interest includes a vehicle, a stop light, a stop sign, or a barrier.

6. The computing device-implemented method of claim 4, comprising determining an acceleration of the vehicle relative to the object of interest.

7. The computing device-implemented method of claim 1, wherein the information representative of the environment is visual information.

8. A system comprising:
a computing device comprising:
a memory configured to store instructions; and
a processor to execute the instructions to perform operations comprising:
receiving information representative of an environment forward of a travelling vehicle that includes an alternative fuel propulsion system;
receiving information representative of a vehicle performance measure;
receiving information representative of a position of an accelerator pedal of the vehicle; and
determining a battery regeneration profile to send to an electric motor of the alternative fuel propulsion system of the vehicle from the received information representative of the position of a pedal, the received information representative of the vehicle performance measure, and received information representative of the environment.

9. The system of claim 8, wherein the performance measure represents a speed of the vehicle.

10. The system of claim 8, wherein the information representative of the environment is camera images of a road segment in front of the vehicle.

11. The system of claim 10, comprising detecting an object of interest from the camera images.

12. The system of claim 11, wherein the object of interest includes a vehicle, a stop light, a stop sign, or a barrier.

13. The system of claim 12, comprising determining an acceleration of the vehicle relative to the object of interest.

14. The system of claim 8, wherein the information representative of the environment is visual information.

15. One or more computer readable media storing instructions that are executable by a processing device, and upon such execution cause the processing device to perform operations comprising:
receiving information representative of an environment forward of a travelling vehicle that includes an alternative fuel propulsion system;
receiving information representative of a vehicle performance measure;
receiving information representative of a position of an accelerator pedal of the vehicle; and
determining a battery regeneration profile to send to an electric motor of the alternative fuel propulsion system of the vehicle from the received information representative of the position of a pedal, the received information representative of the vehicle performance measure, and received information representative of the environment.

16. The one or more computer readable media of claim 15, wherein the performance measure represents a speed of the vehicle.

17. The one or more computer readable media of claim 15, wherein the information representative of the environment is camera images of a road segment in front of the vehicle.

18. The one or more computer readable media of claim 17, comprising detecting an object of interest from the camera images.

19. The one or more computer readable media of claim 18, wherein the object of interest includes a vehicle, a stop light, a stop sign, or a barrier.

20. The one or more computer readable media of claim 18, comprising determining an acceleration of the vehicle relative to the object of interest.

21. The one or more computer readable media of claim 15, wherein the information representative of the environment is visual information.
